(19) United States
(12) Patent Application Publication
(10) Pub. No.: US 2012/0124808 A1
(43) Pub. Date: May 24, 2012

(54) METHOD FOR REDUCING THE INSTALLATION TIME FOR A SUPPLY CHANNEL

(75) Inventors: Benjamin LANDES, Hamburg (DE); Anja NITSCHE, Hamburg (DE)

(73) Assignee: AIRBUS OPERATIONS GMBH, Hamburg (DE)

(21) Appl. No.: 13/344,759

(22) Filed: Jan. 6, 2012

Related U.S. Application Data
(63) Continuation of application No. PCT/EP2010/058307, filed on Jun. 14, 2010.
(60) Provisional application No. 61/223,487, filed on Jul. 7, 2009.

(30) Foreign Application Priority Data
Jul. 7, 2009 (DE) 102009032078.4

(51) Int. Cl. B23P 17/00

(52) U.S. Cl. 29/428

(57) ABSTRACT

A method is introduced for reducing the installation time for a supply channel on a first retaining structure in an aircraft. The method includes, but is not limited to pre-wiring a stowage compartment outside of the aircraft, installing a supply channel unit in the aircraft at a standardized installation position predefined by the first retaining structure. Standardizing the installation steps in this way makes numerous advantages possible, including a reduction in the installation time of the passenger supply channel within the framework of a final assembly of cabin components.

### CROSS-REFERENCE TO RELATED APPLICATIONS

This application is a continuation of International Application No. PCT/EP2010/058307, filed Jun. 14, 2010, which was published under PCT Article 21 (2) and which claims priority to German Patent Application No. 10 2009 032 078.4, filed Jul. 7, 2009 and also priority to U.S. Provisional Patent Application No. 61/223,487, filed Jul. 7, 2009, the disclosures of which applications are hereby incorporated herein by reference.

### TECHNICAL FIELD

The technical field relates to a method for reducing the installation time for a supply channel on a retaining structure in an aircraft. In addition, the technical field relates to an aircraft with a supply channel, which is installed according to the aforementioned method.

### BACKGROUND

Assembly time plays an important role during the assembly of aircraft. In view of the complexity and variety of different components, a lot of time has to be invested on the final assembly line. A high time outlay during final assembly also leads to increased costs. The time outlay may be increased by the assembly of cabin components, which are to be incorporated into the cabin in a plurality of configurations, and must all be separately, individually, and intricately wired.

For example, the installation of passenger supply channels on stowage compartments, e.g., of the kind known from DE 10 2007 030 331 A1 and parallel application WO 2009 003 945 A1, may require that excess cable lengths be provided and secured in the stowage compartments. The stowage compartments must then be wired and secured in the aircraft. The excess cable lengths may be required, since the exact positioning of the passenger supply units to be situated under the stowage compartments is not sufficiently known, and independent of the position of the stowage compartments. Therefore, the individual passenger supply channel elements cannot always be mounted in the same position relative to the stowage compartments. This yields varying distances, for example between the connections in the stowage compartments and connections or cables for the passenger supply channel elements.

After the stowage compartments have been installed, the individual passenger supply channel elements must be correspondingly positioned under the stowage compartments, and the cables must be installed and wired step by step. This procedure may take an enormous amount of time. One way to reduce this time outlay would be to draft individual installation drawings at least for each separate stowage compartment, and possibly for each separate passenger supply channel element to be arranged under the latter. However, this alternative may lead to an elevated work and cost outlay.

Accordingly, it is desirable at least address the foregoing. In addition, other desirable features and characteristics will become apparent from the subsequent summary and detailed description, and the appended claims, taken in conjunction with the accompanying drawings and this background.

### SUMMARY

Described in a first embodiment is a method for reducing the installation time for a passenger supply channel on a first retaining structure in an aircraft. The method exhibits the following steps: pre-wiring an stowage compartment with a first retaining structure outside the aircraft, and installing a passenger supply unit in the aircraft in a standardized installation position predefined by the first retaining structure.

Expressed differently, the first embodiment is based on the installation sites for the passenger supply units being prescribed by a retaining structure. The retaining structure can here be a mounting rail (grid rail) situated on a stowage compartment, for example. Therefore, the retaining structure prescribes the installation sites for the passenger supply units in such a way as to provide for standardization. The position of the passenger supply units is hence now directly linked with the position of the stowage compartments or dependent thereupon.

Because of the standardization, the installation sites of the passenger supply units are known. Therefore, the stowage compartments can already be pre-wired outside of the aircraft. This eliminates the need for excess cable lengths on the passenger supply units.

On the one hand, pre-wiring the stowage compartments can yield a reduction in weight through the elimination of excess cable lengths. Furthermore, pre-wiring outside of the aircraft economizes on the expenditure of work and the valuable time required for final assembly. In addition, installing the passenger supply unit at standardized installation sites also makes it possible to standardize the wiring or pre-wiring of the stowage compartments. This also leads to a reduction in the time outlay. The time expended for maintaining passenger supply units can be reduced by standardizing the wiring as well. Furthermore, standardization enables a more precise documentation and quality control of the wiring and installation process. As opposed to the previous approach, which only had guidelines for cable installation, and required interpretation during the process of installation and subsequent inspection, this can be done by comparing the execution with exact specifications. The mentioned timesavings according to the described method can further be achieved without increasing the overall costs.

In the following, features, details, and possible advantages of a device will be thoroughly discussed based on embodiments. The installation time for a passenger supply channel may be reduced according to the method. The installation time can correspond to a time expended as part of the final assembly of a passenger supply channel.

A passenger supply channel (passenger supply channel, PSC) is a channel that can be situated under the stowage compartments (e.g., overhead stowage compartments) above the passenger seats. The passenger supply channel can integrate passenger supply units (passenger supply units, PSU. For example, the passenger supply unit can accommodate output devices like digital displays (for example, for “Fasten Seatbelt” and “No Smoking”) and screens, for example of televisions for passenger entertainment. The passenger supply unit can further exhibit lamp elements for individual lighting, individual vents, service buttons, e.g., for calling a stewardess, and oxygen (O₂) boxes, for example with breathing masks, which automatically drop down if the pressure in the cabin falls.

The passenger supply channel is installed on a first retaining structure of the aircraft. The first retaining structure can be designed as an attachment, a rail, or a mounting strip. For example, the passenger supply channel can be suspended from or screwed to the first retaining structure. The first retaining structure is here designed to join at least one element, for example the passenger supply unit, with another element, for example an overhead stowage compartment. In other words, the first retaining structure is designed to be arranged on a structure of the aircraft, and have another coupled thereto. For example, the first retaining structure can be integrated into the overhead stowage compartment. The aircraft can here be an airplane or helicopter, for example. Furthermore, the aircraft can be configured for civil or military aviation. For example, the aircraft can further be a passenger and/or cargo plane.

The method for reducing the installation time for the passenger supply channel involves the step of pre-wiring an overhead stowage compartment outside of the aircraft. Pre-wiring can here include a process encompassing the provision of the overhead stowage compartment with wires, cables, and electrical connections. Furthermore, pre-wiring can encompass the arrangement, attachment, and fabrication of necessary electrical wires, cables, lines and contacts. After the pre-wiring step, the overhead stowage compartment can be configured in such a way that it can be used in the aircraft in short order, requiring little time expenditure and possibly no additional wiring steps.

Furthermore, the passenger supply unit can be pre-wired and furnished with connections. After the pre-wiring step is complete, the passenger supply unit can be latched in place at a prescribed location in the aircraft, so that it already establishes a connection with the pre-wired overhead stowage compartment once latched, and is ready for operation. The steps involved in pre-wiring the overhead stowage compartment and passenger supply unit can here take place in parallel or sequentially.

Pre-wiring takes place outside of the aircraft, which facilitates the work, since the wiring space is not limited, thereby also accelerating the work. In addition, pre-wiring outside of the aircraft allows final assembly inside the aircraft to proceed much faster. For example, pre-wiring can be performed in the direct vicinity of the aircraft. As an alternative, pre-wiring can occur in an assembly hangar, and the pre-wired cabin components can subsequently be transported to the aircraft.

The process further involves the step of installing the passenger supply unit in the aircraft, at a standardized installation position predefined by the first retaining structure. Installation can here denote the positioning and assembly of the passenger supply unit. Furthermore, installation can imply a wiring and attachment of the passenger supply unit with other components of the aircraft, such as the overhead stowage compartment. Installation can encompass both electrical and mechanical installation.

The first retaining structure can here be designed as part of the overhead stowage compartment or as a separate component. Furthermore, the first retaining structure can be rigidly secured to the overhead stowage compartment at predefined locations, for example, so that recesses in the first retaining structure always exhibit the same position in relation to the overhead stowage compartment, in this way prescribing standardized installation positions for the passenger supply units.

During installation, the first retaining structure prescribes an installation position for the passenger supply unit. For example, this can be done by having the retaining structure allow assembly only at very specific locations. For example, the first retaining structure can be designed as a rail with a grid pattern. Such a first retaining structure can be situated on or under the overhead stowage compartment, and used to always secure a passenger supply unit to the same location in relation to the overhead stowage compartment.

A predefined installation position can here mean that the first retaining structure prescribe the installation position by means of a punched hole, for example. For example, the installation position could be predefined by the first retaining structure in such a way as to secure an attachment means, for example a screw, approximately 2 cm away from the left edge of the passenger supply channel, or at a first punched hole in the first retaining structure. Additional attachment points can also be prescribed, for example by additional punched holes on the first retaining structure.

Furthermore, the installation position of the passenger supply unit is standardized. For example, this means that the installation position of each passenger supply unit in relation to the respective overhead stowage compartment is always the same. Standardization offers advantages, since it economizes on time. For example, the installation position of the supply unit can be defined by the coordinates of the attachment points for the passenger supply unit in relation to the overhead stowage compartments or other structural elements in an aircraft cabin.

The method according makes it possible to reduce the time it takes to install the passenger supply channel by pre-wiring the overhead stowage compartment outside of the aircraft on the one hand, and standardizing the installation positions by means of the first retaining structure on the other. One approach according to the method described eliminates the need for individual construction and cabling plans for the individual passenger supply units, makes it easier to more precisely document the quality control process for cable installation, and reduces the expenditure of work, and hence the time required during the final assembly of the passenger supply units.

In one embodiment, the first retaining structure exhibits a mounting rail with a perforation. Installation here takes place at the standardized installation position predefined by the first retaining structure using the perforation of the mounting rail. The first retaining structure can be designed as a mounting rail or mounting strip, or encompass the latter. The rail can here be uniformly subdivided. In other words, the perforations on the mounting rail can be arranged at regular intervals.

The perforations of the mounting rail (also called grid-patterned rail) can form a lattice pattern on the rail, or preferably correspond to punch holes spaced equally apart along the longitudinal axis of the rail. A perforation can here manifest itself as a recess or preferably a drilled or punched hole in the rail along one or both sides of the rail. A punched hole on one side of the rail preferably has a punched hole on the other opposite side of the rail.

The passenger supply unit is installed by perforating the mounting rail. In other words, perforating the mounting rail clearly establishes the attachment sites of the passenger supply unit. For example, the mounting rail can be situated under an overhead stowage compartment. An attachment element of the passenger supply unit can then be guided into or along the mounting rail, until the latching site or attachment site has been reached. The use of a mounting rail to install the passenger supply unit makes it possible to achieve a standardization of the installation position for the passenger supply unit in relation to the overhead stowage compartments. This simplifies the assembly process, and saves time on the final assembly line (FAL).

In another embodiment, the perforation exhibits punched holes spaced equally apart along the longitudinal axis of the mounting rail. For example, the punched holes can be comprised of several drilled holes in the rail, if necessary even on opposite sides of the rail. The punched holes are spaced an equal distance apart, e.g., meaning that the midpoints of the punched holes each exhibit the same distance in relation to each other. Punched holes spaced an equal distance apart along the longitudinal axis of the mounting rail helps to standardize installation of the passenger supply channel, and hence to diminish the installation time.

In another embodiment of the invention, the pre-wiring of the overhead stowage compartment is standardized. Standardized can here imply that the step of pre-wiring runs its course identically for all overhead stowage compartments, and possibly passenger supply units as well. For example, a single wiring diagram or wiring protocol (wire installation guide, WIG) can define the pre-wiring of all overhead stowage compartments, and another wiring diagram can possibly define the pre-wiring for all passenger supply units. For example, the latter can establish the cable routing and layout, along with the positions of connections or plug connections and their cabling. Furthermore, the wiring protocol can specify the bending radii of the cables or wires. For example, standardizing the pre-wiring of the overhead stowage compartment makes it possible to economize on the work and time expended during the installation of the passenger supply channel, e.g., when securing the passenger supply units to the overhead stowage compartments, by avoiding individual wiring and installation diagrams for the respective overhead stowage compartment.

In another embodiment, the passenger supply unit exhibits an electrical consumer. The method further involves the following step: automatically establishing an electrical connection between the electrical consumer and a supply line of the aircraft while moving the passenger supply unit to the predefined, standardized installation position. For example, electrical consumers can here be output devices, such as digital displays and screens. As an alternative, electrical consumers can be lamp elements to provide individual lighting for the passengers, vent units, service buttons, and oxygen boxes.

The method for reducing the time for installing a passenger supply channel on a first retaining structure further involves the step of automatically establishing an electrical connection between the electrical consumer and a supply line of the aircraft. Automatically can here mean that no additional human activity is needed for establishing the electrical connection. In other words, the connection can be established without an electrician having to apply his or her expertise. For example, the electrical connection is automatically established during another process, specifically while moving the passenger supply unit to the predefined, standardized installation position. For example, while latching the passenger supply unit in place at the envisaged location under an overhead stowage compartment, a plug connection on the passenger supply unit can here also latch into a bushing in the overhead stowage compartment is provided for this purpose, or establish contact with it.

An electrical connection can here involve setting up a line for an electrical current that can flow over this point of contact. For example, the electrical connection can be established by way of press-in contacts, soldered joints, welded joints, or clamps between two electrical conductors, and preferably by way of plug connections or plugs.

The supply line of the aircraft can be an electrical line that supplies power to the individual aircraft components. The supply line can be connected with a power source, such as a fuel cell. Automatically establishing an electrical connection during installation of the passenger supply unit makes it possible to save time that is even more valuable.

In another embodiment, the method further exhibits the following step of automatically establishing a mechanical connection between the passenger supply unit and the first retaining structure while moving the passenger supply unit to the predefined, standardized installation position. For example, the mechanical connection can here be a non-positive or preferably positive connection. Wedges, clamps, or screws are examples of non-positive mechanical connections. Positive connections may be advantageous in establishing an automatic mechanical connection. Examples of positive mechanical connections include feather keys, toothed gears, and pins or preferably snap connections (click & snap connections).

The mechanical connection is automatically established while moving the passenger supply unit to the predefined, standardized installation position. For example, the mechanical connection can here be established by latching retaining elements on the passenger supply unit into prescribed locations on the first retaining structure. The retaining elements can be designed as snap connections, for example. Automatically establishing a mechanical connection while installing the passenger supply unit also saves on valuable time.

In another embodiment, the method further involves the following step of providing an electrical plug connection on the passenger supply unit for electrically connecting the passenger supply unit to a supply line of the aircraft. The plug connection can exhibit plugs, bushings, couplings, and receptacles. The electrical plug connection can have a male and/or female part. The male part of the electrical plug connection, e.g., a plug, can be situated on the passenger supply unit. The corresponding female part, e.g., a coupling or bushing, can be arranged on the corresponding location of the overhead stowage compartment. As an alternative, both parts of the electrical plug connection can be situated on the passenger supply unit in the form of a connector. In this embodiment, the electrical connector can meet electrical contacts on the overhead stowage compartment while latching in the passenger supply unit, and thereby establish an electrical connection. Providing an electrical plug connection can facilitate any potential maintenance work on the passenger supply unit and its components and cables, and thereby save on time during maintenance.

In another embodiment, the passenger supply unit exhibits a feeder for providing oxygen-containing air to a passenger. The method further involves the following step of automatically establishing an oxygen supply connection between the oxygen-containing air feeder and a corresponding supply line of the aircraft while moving the passenger supply unit to the predefined, standardized installation position. For example, the oxygen-containing air can here be air enriched with oxygen, as envisaged for providing breathing air in the event of a pressure drop. The oxygen-containing air feeder can be connected with an oxygen box, for example. The oxygen box can here be provided with breathing masks, for example, which drop down automatically if the pressure in the cabin falls, and can be pulled over the mouth and nose by a passenger.

The oxygen supply connection can be automatically established with the help of a mechanical plug connection. For example, a connecting element situated on the passenger supply unit can be pulled over the lips of a supply line on an overhead stowage compartment while moving the passenger supply unit to the predefined, standardized installation position. The corresponding supply line for oxygen-containing air can be directly or indirectly connected with a fuel cell, for example.

In another embodiment, the method further involves the following steps of installing the overhead stowage compartment in the aircraft at a standardized installation site predefined by a second retaining structure. The overhead stowage compartment can be installed already prior to the installation of the passenger supply unit, also at predefined, standardized installation sites. The installation sites can here be prescribed by a second retaining structure.

The second retaining structure can here be another mounting rail or strip. As an alternative, the installation sites for the overhead stowage compartment can be defined by a so-called simulated rail. For example, a simulated rail can here consist of frames of an aircraft spaced an equal distance apart from each other, enabling them to prescribe an exact position.

Standardizing the installation of the overhead stowage compartment in this way saves on more time during final assembly. The step of installing the passenger supply unit can take place right after the step of installing the overhead stowage compartment in the aircraft. After the overhead stowage compartment has been installed or already before the overhead stowage compartment is pre-wired, a first retaining structure, for example a mounting rail, can here be situated under the overhead stowage compartment. Installation of the overhead stowage compartment is then oriented toward this first retaining structure.

In another embodiment, the method further involves the following step of installing the passenger supply unit on the overhead stowage compartment. The first retaining structure is here arranged on the overhead stowage compartment.

A second embodiment describes an aircraft with cabin components installed according to the method described above. Additional features and advantages may be gleaned by the person skilled in the art from the following description of exemplary embodiments, which are not to be construed as limiting, however, drawing reference to the attached drawings.

### BRIEF DESCRIPTION OF THE DRAWINGS

The present invention will hereinafter be described in conjunction with the following drawing figures, wherein like numerals denote like elements, and:

FIG. 1 shows a diagrammatic view of a method for installing a passenger supply channel according to an exemplary embodiment;

FIG. 2 shows a diagrammatic side view of installed passenger supply units and overhead stowage compartments, which were installed according to an exemplary embodiment;

FIG. 3 shows a diagrammatic cross section through passenger supply units and overhead stowage compartments installed according to an exemplary embodiment with a mounting rail;

FIG. 4 shows a diagrammatic view of the wiring for passenger supply units and overhead stowage compartments installed according to an exemplary embodiment;

FIG. 5 shows a diagrammatic view of an alternative arrangement of the electrical connection between the passenger supply unit and a supply line above the overhead stowage compartment;

FIG. 6a shows a diagrammatic view of an exemplary embodiment of a passenger supply channel wired according to an exemplary embodiment; and

FIG. 6b shows a diagrammatic view of an exemplary embodiment of a passenger supply channel wired according to an exemplary embodiment without the surrounding geometry.

All figures are only diagrammatic depictions of methods according to exemplary embodiments, devices installed and components thereof. In particular, distances and dimensional correlations are not presented to scale on the figures.

### DETAILED DESCRIPTION

The following detailed description is merely exemplary in nature and is not intended to limit application and uses. Furthermore, there is no intention to be bound by any theory presented in the preceding background or summary or the following detailed description.

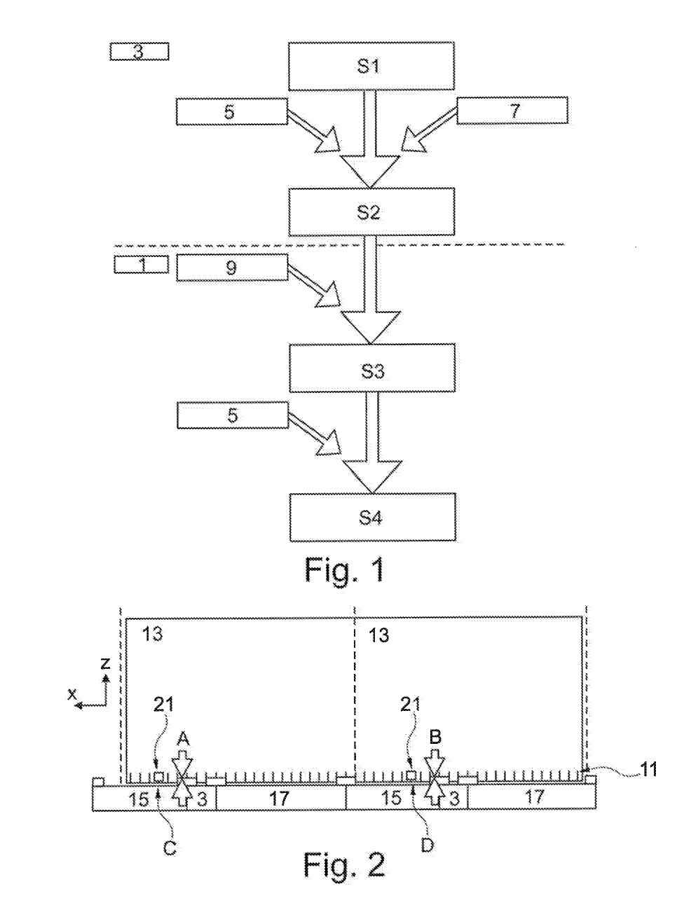

FIG. 1 shows a diagrammatic view of a method for installing a passenger supply channel according to an exemplary embodiment. Steps S1 and S2 here take place outside 3 of the aircraft, while steps S3 and S4 take place inside 1 of the aircraft. Step S1 involves providing the overhead stowage compartments 13 with excess cable lengths. In addition, step S1 can also involve providing passenger supply units 15 with very little or no excess cable length.

Step S2 encompasses pre-wiring the individual overhead stowage compartments 13 and providing the overhead stowage compartments 13 with electrical connecting elements (connectors) 21. Providing excess cable lengths on the overhead stowage compartments 13 and correspondingly pre-wiring can only be accomplished thanks to the method according to the invention, since the exact position of the passenger supply units 15 under the overhead stowage compartments 13 can now be predicted. Furthermore, step S2 can encompass pre-wiring the individual passenger supply units 15, should this become necessary. For example, the passenger supply unit 15 can be furnished with a cable loop that hangs down on one side, for example on a left or right corner, and in step S4 can be connected with a plug, for example the electrical connecting element 21. In addition, a cable clip can here be situated on the passenger supply unit 15 or passenger supply channel panel 23.

Pre-wiring in step S2 can take place with the assistance of a so-called pre-wiring plan 7 (wire installation guide, WIG). The pre-wiring plan 7 is here standardized, and valid for each individual overhead stowage compartment 13, and possibly for each passenger supply unit 15. In other words, the overhead stowage compartments 13 can be pre-wired without any individual construction plans or drawings for each overhead stowage compartment, thanks to a precise determination of the installation position (based on the PSC plotter plan 5 in combination with the WIG 7). Furthermore, a passenger supply channel plotter plan (PSC plotter plan) 5 is used when pre-wiring the individual overhead stowage compartments 13. The passenger supply channel plotter plan can here indicate the positions of the individual passenger supply units 15 along the mounting rail, as depicted on FIG. 2.

Step S3 takes place inside 1 of the aircraft, and encompasses installing the pre-wired overhead stowage compartments 13 with connecting elements. Individual overhead stowage compartment installation drawings 9 can be used when installing the pre-wired overhead stowage compartments 13.

Passenger supply units 15 are installed on the overhead stowage compartments 13 in step S4. This also takes place inside 1 of the aircraft. The passenger supply units 15 must also be installed using the passenger supply channel plotter plan 5 (as shown on FIG. 2). For example, the wiring plan 7 can here be valid for different types of aircraft and various embodiments of overhead stowage compartments 13 and passenger supply units 15. In particular, an individual wiring plan 7 is preferably valid for all overhead stowage compartments 13 and possibly passenger supply units 15 inside an aircraft.

The wiring plan 7 can here impart the position of each electrical connecting element 21 along the mounting rail. For example, the wiring plan 7 can specify this in the form of one or more drawings. Furthermore, the wiring plan 7 can describe the cable progression and bending radii of the cables inside a passenger supply unit 15. For example, the positions of contacts and cable clamps can here be indicated. The wiring plan 7 can be valid both during the first installation and during maintenance steps. The approach leads to enormous timesavings during the final assembly of the cabin components 13, 15. This is enabled primarily by a pre-wiring of the cabin components 13, 15 outside 1 of the aircraft. Furthermore, the fact that individual construction and cabling plans for the separate components are no longer necessary yields significant timesavings.

Consequently, the method according to an exemplary embodiment additionally makes it possible to achieve standardization, and hence save on time, during the installation of overhead stowage compartments 13 with passenger supply units 15. For example, timesavings of about approximately 60% can be achieved during the final assembly of an individual passenger supply unit. Another advantage to the approach according to an exemplary embodiment of the invention lies in the fact that maintenance can be significantly facilitated, since the individual passenger supply units 15 and oxygen boxes 17 can be removed without having to disassemble the surrounding passenger supply channel panel 23. The reason for the above is that the passenger supply units 15 exhibit no excess cable lengths that might extend into the area of the adjacent passenger supply channel panel 23.

FIG. 2 presents a diagrammatic side view of installed passenger supply units 15 and overhead stowage compartments 13, which were installed according to an exemplary embodiment. The side view is shown on the x-z plane. It also presents an exemplary view of what a passenger in the aisle between the seats would see looking at the overhead stowage compartment 13 from the front. FIG. 2 depicts the so-called passenger supply channel plotter plan 5, which can reveal the mounting position in which each passenger supply unit 15 is to be situated or is situated. Two overhead stowage compartments 13 with a mounting rail 11 are situated adjacent to each other. The passenger supply units 15 are arranged on the mounting rail 11. For example, a passenger supply unit 15 can be installed or attached on mounting position no. 7 marked A. A second passenger supply unit 15 can be installed on mounting position no. 34 marked B, for example.

By precisely defining the position of the passenger supply unit 15 under the overhead stowage compartment 13, a position of a connecting element 21 is implicitly defined. The exact definition is contained in the wiring plan 7, and is valid for each overhead stowage compartment 13 in each aircraft. For example, the electrical connecting element 21 is located a respective three mounting positions in front of the position where the passenger supply unit 15 is attached. In the example shown on FIG. 2, the first connecting element is situated on mounting position no. 4 marked C (C=A−3). The second supply element 21 is located on mounting position 31 marked D (D=B−3).

The final wiring of the overhead stowage compartment 13 and potentially the passenger supply unit 15 can also be implicitly defined by the prescribed mounting positions C, D of the electrical connecting element on the mounting rail 11, and is specified in the wiring plan 7. For example, the wiring plan 7 can further also indicate the mounting position of an oxygen box 17 on the mounting rail 11 under the overhead stowage compartment 13.

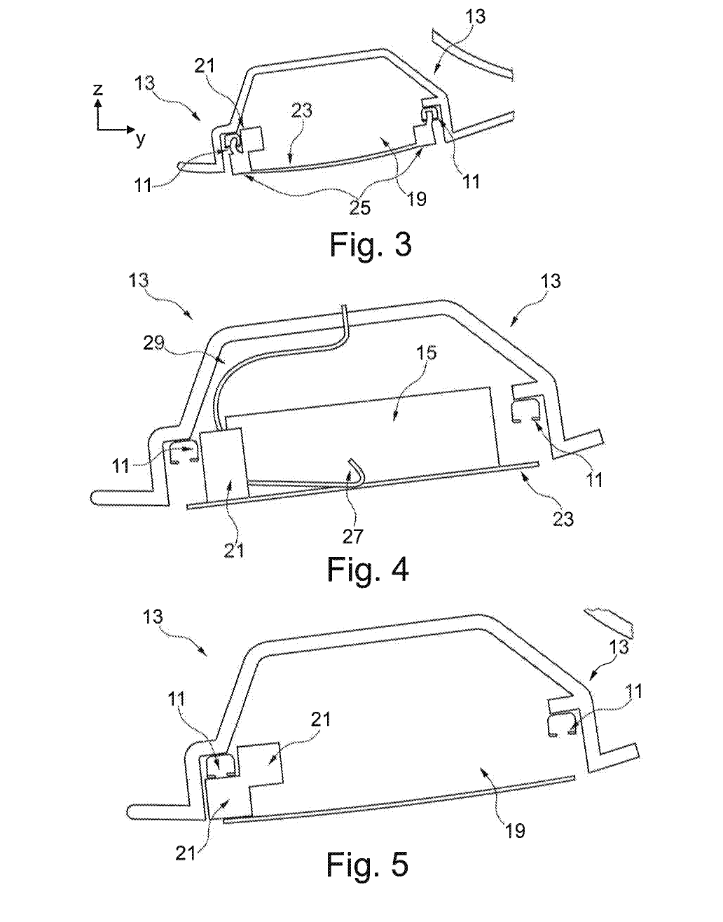

FIG. 3 shows a diagrammatic cross section through passenger supply units 15 and overhead stowage compartments 13 installed according to an exemplary embodiment of the invention with a mounting rail 11. The cross section is shown in the z-y plane. The passenger supply channel 19 is situated under or between the overhead stowage compartments 13. Passenger supply units 15 can be accommodated in the latter. These can be covered by a passenger supply channel panel 23. FIG. 3 depicts the mechanical connection between the passenger supply channel panel 23 or a passenger supply unit 15 and the mounting rail 11.

The mounting rail 11 is respectively situated on or under the overhead stowage compartments 13. A mechanical connecting unit 25, such as a clamp or screw, can be latched into or suspended from the latter. For example, this can be done by guiding a passenger supply unit 15 or passenger supply channel panel 23 to the mounting rail 11 from below.

An electrical connecting element 21 can also automatically latch into the mounting rail 11. For example, this can also take place while guiding the passenger supply unit 15 to the mounting rail 11. The electrical connecting element 21 can be laterally situated on the mounting rail 11. The electrical connecting element 21 can further exhibit an offset in both the y and x direction relative to the mechanical connecting unit 25.

FIG. 4 shows a diagrammatic view of the wiring for passenger supply units 15 and overhead stowage compartments 13 installed according to an exemplary embodiment. Mechanical connecting units 25 are not depicted on FIG. 4. The electrical connecting element 21 is latched into the sides of the mounting rail 11. Prior to installation, the connecting element 21 can either be arranged on the passenger supply unit 15 completely, situated on the passenger supply unit 15 only as a plug element, and laterally secured to the mounting rail 11 as another bushing element, or accommodated completely in the overhead stowage compartment 13 by means of the mounting rail 11 before installation. The electrical connecting element 21 is preferably arranged completely on the passenger supply unit 15 prior to installation, and automatically latches into the mounting rail 11 as the passenger supply unit 15 moves toward the predefined, standardized installation position, thereby establishing the electrical contact between an electrical consumer in the passenger supply unit 15 and a supply line in the aircraft. An electrical supply line in the aircraft can be connected with the electrical connecting element 21 by means of a wire 29 in the overhead stowage compartment 13. A wire 27 electrically contacts the passenger supply unit 15 with the electrical connecting element 21.

FIG. 5 shows a diagrammatic view of an alternative embodiment of the electrical connecting element 21 between the passenger supply unit 15 and a supply line above the overhead stowage compartment 13. For example, the electrical connecting element 21 can here be situated laterally relative to the mounting rail 11. As an alternative, the electrical connecting element 21 can be located under the mounting rail 11.

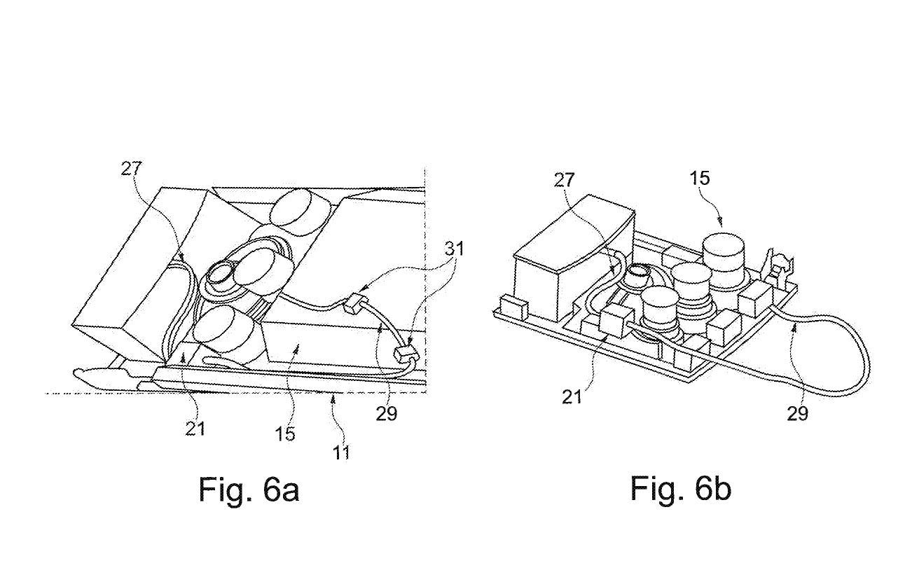

FIG. 6A and FIG. 6B show a diagrammatic view of an exemplary embodiment of a passenger supply channel wired according to an exemplary embodiment. FIG. 6A here depicts the pre-wiring with a surrounding geometry, and FIG. 6B without the surrounding geometry. FIG. 6A and FIG. 6B each illustrate the wiring between the passenger channel unit 15, electrical connecting element 21, and overhead stowage compartment 13. The wire 27 establishes a connection between the electrical connecting element 21 and the passenger supply unit 15. In this case, wire 27 exhibits very little or no excess wire length.

The wire 29 establishes a connection between the electrical connecting element 21 and overhead stowage compartment 13. Prior to installation, the wire 29 exhibits an excess length on the overhead stowage compartment 13. During installation, cable clamps 31 are used to secure the wire 29 outside 3 of the aircraft, for example according to the wiring plan 7. In this exemplary embodiment, the connecting element 21 is arranged on the mounting rail 11 by means of a plug connection.

In conclusion, it is pointed out that terms like “comprising” or the like are not intended to rule out the provision of additional elements or steps. Let it further be noted that “a” or “an” do not preclude a plurality. In addition, features described in conjunction with the different embodiments can be combined with each other however desired. It is also noted that the reference numbers in the claims are not to be construed as limiting the scope of the claims. Moreover, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for reducing an installation time for a passenger supply channel on a first retaining structure in an aircraft, the method comprising:
pre-wiring an stowage compartment with the first retaining structure outside of the aircraft; and
installing a passenger supply unit in the aircraft at a standardized installation position that is predefined by the first retaining structure.

2. The method of claim 1,
wherein the first retaining structure comprises a grid-patterned rail with a perforation;
wherein the installing takes place at the standardized installation position that is predefined by the first retaining structure using the perforation of the grid-patterned rail.

3. The method of claim 2,
wherein the perforation comprises punched holes spaced substantially equally apart along a longitudinal axis of the grid-patterned rail.

4. The method of claim 1,
wherein the pre-wiring of the stowage compartment is a standardized pre-wiring.

5. The method of claim 1,
wherein the passenger supply unit comprises an electrical consumer,
the method further comprising:
automatically establishing of an electrical connection between the electrical consumer and a supply line of the aircraft while moving the passenger supply unit to the standardized installation position.

6. The method of claim 1, further comprising
automatically establishing of a mechanical connection between the passenger supply unit and the first retaining structure while moving the passenger supply unit to the standardized installation position.

7. The method of claim 1, further comprising
provisioning of an electrical plug connection on the passenger supply unit for electrically connecting the passenger supply unit to a supply line of the aircraft.

8. The method of claim 1,
wherein the passenger supply unit comprises a feeder configured to provide oxygen-containing air to a passenger;
the method further comprising
automatically establishing of an oxygen supply connection between the feeder for the oxygen-containing air and a corresponding supply line of the aircraft while moving the passenger supply unit to the standardized installation position.

9. The method of claim 1, further comprising:
installing of the stowage compartment in the aircraft at a standardized installation site predefined by a second retaining structure.

10. The method of claim 9, further comprising:
installing of the passenger supply unit on the stowage compartment; and
arranging the first retaining structure on the stowage compartment.
